(19) United States
(12) Patent Application Publication
(10) Pub. No.: US 2014/0017394 A1
(43) Pub. Date: Jan. 16, 2014

(54) CATHODE COMPOSITION

(71) Applicants: Marcus Wegner, Leonberg (DE); Jan Tomforde, Stuttgart (DE); Ulrich Hasenkox, Ditzingen (DE); Jens Grimminger, Leonberg (DE); Martin Tenzer, Uterensingen (DE); Ralf Liedtke, Stuttgart (DE)

(72) Inventors: Marcus Wegner, Leonberg (DE); Jan Tomforde, Stuttgart (DE); Ulrich Hasenkox, Ditzingen (DE); Jens Grimminger, Leonberg (DE); Martin Tenzer, Uterensingen (DE); Ralf Liedtke, Stuttgart (DE)

(21) Appl. No.: 13/979,040

(22) PCT Filed: Nov. 16, 2011
(86) PCT No.: PCT/EP11/70274

§ 371 Date: Sep. 25, 2013

(30) Foreign Application Priority Data
Jan. 14, 2011 (DE) 10 2011 002 720.3

(51) Int. Cl. H01M 4/60; H01M 4/04; H01M 4/38

(52) U.S. Cl. CPC H01M 4/602; H01M 4/38; H01M 4/0402
USPC 427/58; 429/218.1; 429/213; 252/182.1; 252/511

(57) ABSTRACT

A cathode composition for an alkali-sulfur cell, e.g., a lithium-sulfur cell, includes, in addition to elementary sulfur, at least one material having covalently and/or conically bound sulfur, for example, a sulfur composite material, a sulfurous polymer, a metal sulfide, or a nonmetal sulfide.

### BACKGROUND OF THE INVENTION

1. FIELD OF THE INVENTION

The present invention relates to a cathode composition for an alkali-sulfur cell, in particular a lithium-sulfur cell, a manufacturing method for a cathode for an alkali-sulfur cell, and a corresponding cathode and alkali-sulfur cell.

2. DESCRIPTION OF THE RELATED ART

In order to be able to achieve ranges of greater than 200 km using an electric vehicle with acceptable battery weight, research is continuously being made for novel battery materials and technologies. Lithium-sulfur cells represent a promising candidate for this purpose. Sulfur is reduced to form lithium sulfide via polysulfides during the discharge in lithium-sulfur cells. Vice versa, oxidation of the sulfide to form sulfur occurs during the charging of the cell. Presently, energy densities of up to 350 Wh/kg may be achieved using lithium-sulfur cells. However, such cells typically only achieve a cycle number of just over 100 cycles.

### BRIEF SUMMARY OF THE INVENTION

The object of the present invention is a cathode composition for an alkali-sulfur cell, in particular a lithium-sulfur cell, or the manufacture of a cathode of a lithium-sulfur cell, which includes elementary sulfur and at least one material having covalently and/or ionically bound sulfur.

A material having covalently and/or ionically bound sulfur may be understood in the sense of the present invention in particular as a material in which the sulfur is covalently and/or ionically bound to another chemical element, in particular which is not sulfur or an alkali metal, such as lithium.

The material having covalently and/or ionically bound sulfur is preferably provided as a solid during operation of the alkali-sulfur cell. In particular, the material having covalently and/or ionically bound sulfur may be insoluble in alkali-sulfur cell electrolytes, in particular in lithium-sulfur cell electrolytes, in particular at the operating temperature of the alkali-sulfur cell.

By admixing the material having covalently and/or ionically bound sulfur, sulfur seeds, for example, in the nanometer and subnanometer range, are introduced into the cathode composition. These may advantageously be used as a starting point, in particular as crystallization seeds, for the sulfur deposition during the charging procedure. The sulfur may thus be deposited homogeneously and in small particles during the charging procedure. The sulfur utilization may thus advantageously be improved, the mechanical strain may be reduced, and finally the cycle stability may be improved.

Within the scope of one specific embodiment, the material having covalently and/or ionically bound sulfur is selected from the group including sulfur composite materials, sulfurous polymers, metal sulfides, nonmetal sulfides, and combinations thereof. Such materials have proven to be suited as sulfur deposition accelerators in particular. In particular organic polymers or polymers based on carbon are understood in particular as a polymer in the sense of the present invention.

Within the scope of another specific embodiment, the material having covalently and/or ionically bound sulfur is a sulfur composite material. Sulfur composite materials have proven to be particularly advantageous as sulfur deposition accelerators.

Within the scope of another specific embodiment, the material having covalently and/or conically bound sulfur, in particular the sulfur composite material, has an average primary particle size in the range from ≧5 nm through ≦1000 nm, for example, ≧50 nm through ≦500 nm, in particular measured using scanning electron microscopy (SEM). The primary particles may be agglomerated to form larger secondary particles, which may disintegrate during the cathode manufacturing.

Within the scope of another specific embodiment, the sulfur composite material has sulfur areas having an average diameter of less than 1000 nm, in particular less than 100 nm, for example, less than 1 nm, optionally less than 0.1 nm, for example, below the scanning-electron-microscopic detection threshold. Sulfur areas of this size have proven to be advantageous in particular as crystallization seeds for the sulfur deposition.

Within the scope of another specific embodiment, the sulfur, of the sulfur composite material is provided homogeneously distributed in the sulfur composite material. The formation of sulfur agglomerates may thus advantageously be reduced.

Within the scope of another specific embodiment, the sulfur composite material is a sulfur-polymer composite material. Sulfur-polymer composite materials have proven to be advantageous in particular, since polymers may form covalent sulfur-polymer bonds and sulfur-polymer composite materials may be manufactured well having small sulfur areas, small particle sizes, and a homogeneous sulfur distribution.

Within the scope of another specific embodiment, the sulfur composite material includes a polyacrylonitrile-sulfur composite material. In particular, the sulfur composite material may be a polyacrylonitrile-sulfur composite material. Polyacrylonitrile-sulfur composite materials advantageously have very good cycle stability and high sulfur utilization. In addition, polyacrylonitrile-sulfur composite materials may be manufactured well having a homogeneous sulfur distribution in the subnanometer/nanometer range in the polymer framework. In addition, the sulfur in polyacrylonitrile-sulfur composite materials is bound relatively fixedly or covalently in the composite material.

Within the scope of another specific embodiment, the sulfur-composite material, in particular the polyacrylonitrile-sulfur composite material, is manufactured by heating a mixture of elementary sulfur and at least one polymer, in particular polyacrylonitrile, for example, to a temperature in a range from ≧200° C. through ≦800° C.

Within the scope of another specific embodiment, the sulfur composite material, in relation to the total weight of the sulfur composite material, includes ≧5 wt.-% through ≦80 wt.-%, for example, ≧20 wt.-% through ≦50 wt.-% sulfur.

In particular, the sulfur composite material, in relation to the total weight of the sulfur composite material, may include
≧5 wt.-% through ≦80 wt.-%, for example, ≧20 wt.-% through ≦50 wt.-% sulfur and
≧20 wt.-% through ≦95 wt.-%, for example, ≧50 wt.-% through ≦80 wt.-% polymer(s), in particular polyacrylonitrile,

or may be made thereof. The sum of the weight percent values of polymers and sulfur may result in particular in a total of 100 wt.-%, in relation to the total weight of the sulfur composite material.

Within the scope of another specific embodiment, the cathode composition also includes at least one binder. For example, the at least one binder may be selected from the group including polyvinylidene fluoride (PVDF), polyvinylidene fluoride hexafluoropropylene (PVDF-HFP), polyethylene oxide (PEO), water-soluble binders, for example, cellulose-based binders, and combinations thereof. Such binders have proven to be advantageous in particular for the cathode composition according to the present invention.

Within the scope of another specific embodiment, the cathode composition also includes at least one conductive additive. For example, the at least one conductive additive is selected from the group including graphite, carbon black, carbon nanotubes, carbon nanofibers, activated carbon, and combinations thereof. Such conductive additives have proven to be advantageous in particular for the cathode composition according to the present invention.

Within the scope of another specific embodiment, the cathode composition also includes at least one solvent. For example, the at least one solvent may be selected from the group including N-methyl-2-pyrrolidinone (NMP), dimethyl sulfoxide (DMSO), dimethyl formamide (DMF), dimethyl acetamide (DMAC), and combinations thereof. Such solvents have proven to be advantageous in particular for the cathode composition according to the present invention.

The cathode composition according to the present invention may include in particular elementary sulfur, one or multiple binders, one or multiple materials having covalently and/or conically bound sulfur, for example, sulfur composite materials, one or multiple conductive additives, and optionally one or multiple solvents.

Within the scope of another specific embodiment, the cathode composition includes, in relation to the total weight of the cathode composition:
≧10 wt.-% through ≦80 wt.-%, for example, ≧15 wt.-% through ≦60 wt.-% elementary sulfur, and/or
≧5 wt.-% through ≦50 wt.-%, for example, ≧10 wt.-% through ≦25 wt.-% binders, and/or
≧5 wt.-% through ≦50 wt.-%, for example, ≧10 wt.-% through ≦25 wt.-% conductive additives, and/or
≧0.1 wt.-% through ≦50 wt.-%, for example, ≧1 wt.-% through ≦25 wt.-% materials having covalently and/or ionically bound sulfur, in particular sulfur composite materials, and/or
≧0 wt.-% through ≦50 wt.-%, for example, ≧0 wt.-% through ≦25 wt.-% solvents.

The sum of the weight-percent values of elementary sulfur, binders, conductive additives, and materials having covalently and/or ionically bound sulfur, in particular sulfur composite materials, and optionally solvents, results in particular in a total of 100 wt.-%, in relation to the total weight of the cathode composition. The cathode composition may optionally be made of such a composition.

Another object of the present invention is a method for manufacturing a cathode for an alkali-sulfur cell, in particular a lithium-sulfur cell, including method step a):

mixing elementary sulfur, at least one binder, at least one material having covalently and/or ionically bound sulfur, in particular a sulfur composite material, at least one conductive additive, and at least one solvent, in particular a cathode composition according to the present invention having at least one solvent, or providing a cathode composition according to the present invention containing a solvent.

Furthermore, the method may include method step b): applying, for example, using a coating knife, the composition, in particular from method step a), to a current conductor, for example, a metal foil. For example, a layer may be applied to the current conductor which has a layer thickness in a range from ≧20 μm through ≦200 μm.

In addition, the method may include method step c): drying the assembly, in particular from method step b). The drying may take place at a temperature of higher than 50° C., for example, and under vacuum, for example.

A further object of the present invention is a cathode for an alkali-sulfur cell, in particular a lithium-sulfur cell, which is manufactured from a cathode composition according to the present invention and/or by a method according to the present invention.

Furthermore, the present invention relates to an alkali-sulfur cell, in particular a lithium-sulfur cell, which includes a cathode according to the present invention. Such alkali-sulfur cells, in particular lithium-sulfur cells, may be used, for example, in notebooks, PDAs, tablet computers, mobile telephones, electronic books, power tools, garden tools, vehicles, for example, hybrid, plug-in hybrid, and electric vehicles.

### BRIEF DESCRIPTION OF THE DRAWINGS

FIG. 1 shows a schematic cross section through a conventional cathode composition of a lithium-sulfur cell before (left) and after (right) the cyclization.

FIG. 2 shows a schematic cross section through a specific embodiment of a cathode composition according to the present invention before (left) and after (right) the cyclization.

### DETAILED DESCRIPTION OF THE INVENTION

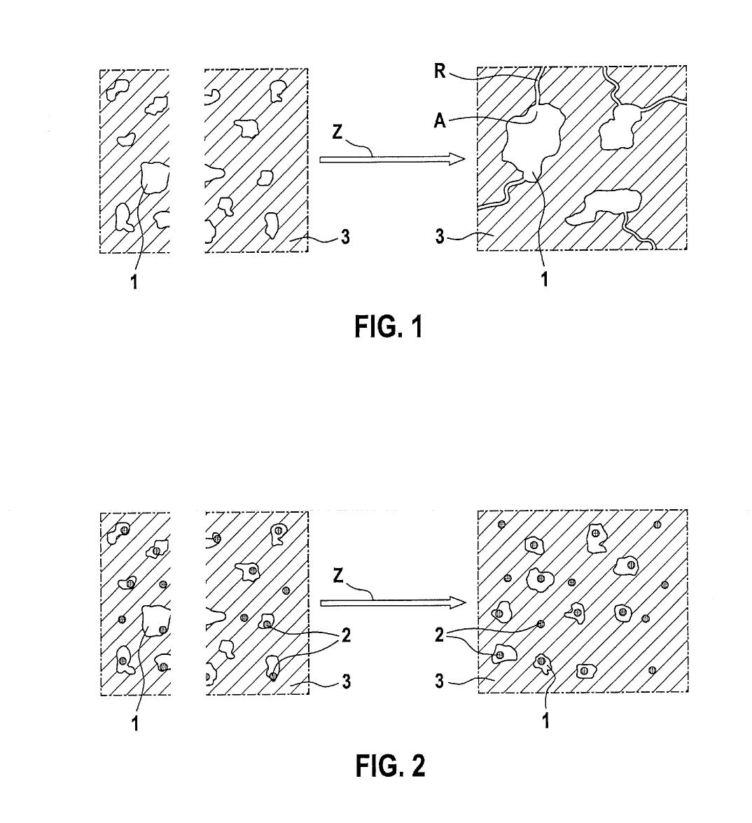

FIG. 1 shows that conventional cathode compositions of lithium-sulfur cells include elementary sulfur 1, which is incorporated in a binder-conductive additive matrix 3. In the case of such cathode compositions, sulfur agglomerates A, which become larger and larger with increasing cycle numbers, form during cyclization Z. This results in mechanical tensions within the cathode and finally in cracking R. The poorer electrical contacting resulting therefrom is accompanied by an increase of the cell resistance and therefore a reduction of the cell voltage. Larger sulfur particles additionally reduce the sulfur utilization. Moreover, an insulating lithium sulfide layer (not shown) may form on the large sulfur agglomerates in the course of the discharging procedure, which obstructs or prevents the utilization of the sulfur located underneath.

FIG. 2 shows that within the scope of this specific embodiment of a cathode composition according to the present invention, in addition to particles made of elementary sulfur 1, particles made of a material 2 having covalently and/or ionically bound sulfur are also incorporated homogeneously distributed in a binder-conductive additive matrix 3. The material having covalently and/or ionically bound sulfur may be, for example, a sulfur composite material, a sulfurous polymer, a metal sulfide, such as nickel sulfide, or a non-metal sulfide. By admixing material particles 2, sulfur seeds in the nanometer and subnanometer range are introduced into the cathode composition. These may advantageously be used as a starting point, in particular as crystallization seeds, for the sulfur deposition during cyclization Z. The sulfur may thus be deposited homogeneously and in small particles during cyclization Z.

### EXAMPLES

### Example 1

### Manufacturing of a Sulfur-Polyacrylonitrile Composite Material

15 g elementary sulfur and 5 g polyacrylonitrile were mixed and heated to 330° C. for 6 hours. The sulfur-polyacrylonitrile composite material thus manufactured had 40 wt.-% sulfur.

### Example 2

### Manufacturing of a Cathode Composition

5 g elementary sulfur and 1 g of the sulfur-polyacrylonitrile composite material from Example 1 were stirred together with N-methyl-2-pyrrolidinone (NMP) in a SpeedMixer at 10,000 RPM for 20 minutes. 1 g carbon black (Super-P Li from Timcal) was then added. After a further 20 minutes of stirring time, 1 g graphite and 2 g PVDF were added. The mixture was stirred for a further 120 minutes.

### Example 3

### Manufacturing of a Cathode

The mixture from example 2 was applied using a coating knife to an aluminum foil. The cathode was then dried for two hours at 60° C. on a heating plate. The assembly was subsequently transferred into a vacuum furnace and dried for a further 12 hours at 60° C.

The resulting cathode was installed in a lithium-sulfur cell. The lithium-sulfur cell thus manufactured had a homogeneous sulfur distribution during the charging procedure.

1-15. (canceled)

16. A cathode composition for an alkali-sulfur cell, comprising:
elementary sulfur; and
at least one material having at least one of covalently-bound sulfur and ionically-bound sulfur.

17. The cathode composition as recited in claim 16, wherein the material having at least one of covalently-bound sulfur and ionically-bound sulfur has an average primary particle size in a range from ≧5 nm to ≦1000 nm.

18. The cathode composition as recited in claim 17, wherein the material having at least one of covalently-bound sulfur and ionically-bound sulfur includes at least one of sulfur composite materials, sulfurous polymers, metal sulfides, and nonmetal sulfides.

19. The cathode composition as recited in claim 18, wherein the material having at least one of covalently-bound sulfur and ionically-bound sulfur is a sulfur composite material.

20. The cathode composition as recited in claim 19, wherein the sulfur composite material has sulfur areas having an average diameter of less than 1000 nm.

21. The cathode composition as recited in claim 19, wherein the sulfur of the sulfur composite material is provided homogeneously distributed in the sulfur composite material.

22. The cathode composition as recited in claim 19, wherein the sulfur composite material is a sulfur-polymer composite material.

23. The cathode composition as recited in claim 19, wherein the sulfur composite material is a polyacrylonitrile-sulfur composite material.

24. The cathode composition as recited in claim 19, wherein the sulfur composite material is manufactured by heating a mixture made of elementary sulfur and polyacrylonitrile.

25. The cathode composition as recited in claim 19, wherein the sulfur composite material includes ≧5 wt. % to ≦80 wt. % sulfur in relation to the total weight of the sulfur composite material.

26. The cathode composition as recited in claim 16, further comprising:
at least one of:
(i) a binder including at least one of polyvinylidene fluoride, polyvinylidene fluoride hexafluoropropylene, polyethylene oxide, and water-soluble binders;
(ii) a conductive additive including at least one of graphite, carbon black, carbon nanofibers, carbon nanotubes, and activated carbon; and
(iii) a solvent including at least one of N-methyl-2-pyrrolidinone, dimethyl sulfoxide, dimethyl formamide, and dimethyl acetamide.

27. The cathode composition as recited in claim 16, wherein the cathode composition includes, in relation to the total weight of the cathode composition, at least one of:
≧10 wt. % to ≦80 wt. % elementary sulfur;
≧5 wt. % to ≦50 wt. % binders;
≧5 wt. % to ≦50 wt. % conductive additives;
≧0.1 wt. % to ≦50 wt. % materials having at least one of covalently bound sulfur and ionically bound sulfur; and
≧0 wt. % to ≦50 wt. % solvents;
and wherein the sum of the weight-percent values of elementary sulfur, binders, conductive additives, materials having at least one of covalently bound sulfur and ionically bound sulfur, and solvents, is a total of 100 wt. % of the total weight of the cathode composition.

28. A method for manufacturing a cathode for an alkali-sulfur cell, comprising:
a) mixing elementary sulfur, at least one binder, at least one material having at least one of covalently bound sulfur and ionically bound sulfur, at least one conductive additive, and at least one solvent to provide a cathode composition;
b) applying the cathode composition to a current conductor to form an assembly, and
c) drying the assembly to form the cathode.

29. The method as recited in claim 28, wherein the alkali-sulfur cell is a lithium-sulfur cell.
